(19) United States
(12) Patent Application Publication
(10) Pub. No.: US 2014/0355060 A1
(43) Pub. Date: Dec. 4, 2014

(54) IMAGE FORMING APPARATUS, METHOD FOR CONTROLLING IMAGE FORMING APPARATUS, AND STORAGE MEDIUM FOR DISPLAYING IMAGE INFORMATION ON A PREVIEW SCREEN

(71) Applicant: CANON KABUSHIKI KAISHA, Tokyo (JP)

(72) Inventor: Keiko Kamoi, Yokohama-shi (JP)

(21) Appl. No.: 14/290,860

(22) Filed: May 29, 2014

(30) Foreign Application Priority Data
May 31, 2013 (JP) 2013-115487

(51) Int. Cl. G06F 3/12

(52) U.S. Cl. CPC G06F 3/1256; G06F 3/1208
USPC 358/1.15

(57) ABSTRACT

In an image forming apparatus in which a reading unit reads image information stored in an external storage unit and the read image information is analyzed to generate print information for carrying out printing, a print setting that is not to be set when printing the image information are identified based on a result of analyzing the image information. Preview image information is then generated from the stored image information, and information indicating the identified print setting is displayed on a preview screen that displays the generated preview image information.

### BACKGROUND OF THE INVENTION

1. Field of the Invention

The present invention relates to an image forming apparatus, a method for controlling an image forming apparatus, and a storage medium.

2. Description of the Related Art

Information devices that can access a removable medium without involving an information processing device (e.g., personal computer (PC)) are becoming widely available. As an image forming apparatus provided with a port for accessing a file in a removable medium and with a function for inputting and outputting an image to and from the removable medium becomes commercially available, a user can print an image in the removable medium which has been stored through a digital camera, a PC, or another information device. In addition, as there are an increasing number of image forming apparatuses that can display a preview for improved user friendliness in selecting files, the user can select a file while checking an image in the removable medium. Such an image preview function can advantageously prevent the user from selecting a wrong file.

Images in a variety of formats may be stored in a removable medium, and when a stored image is to be printed with the use of a media direct print function of an image forming apparatus, there may be a case where a selected image is in a format that is not supported by the image forming apparatus. Specifically, a case where the image format is not supported includes, for example, a case where a given image has a compression ratio or resolution that does not fall within an allowable range for printing or a case where a given file is damaged.

Conventionally, in such cases as described above, typically, printing is performed by skipping an image that cannot be printed, or an error message is displayed at the time of printing. According to Japanese Patent Application Laid-Open No. 2002-254779, when a file contains an image that cannot be printed (error page), the file is printed excluding the error page, or the file is printed to a preceding page of the error page.

In addition, according to Japanese Patent Application Laid-Open No. 2010-068196, if decoding processing performed when a preview of an image is displayed has failed, that image is not printed.

There is still a case where an image of which a preview can be displayed cannot be printed depending on print settings. Japanese Patent Application Laid-Open No. 2010-068196 does not take such a case into consideration.

For example, with a printing device having a limitation of an allowable range of the number of pixels within which an image is processable for printing, the number of pixels in a vertical direction or a horizontal direction may fall outside the allowable range, when the image is rotated. In that case, depending on image data, the printing device is unable to print the image based on print settings that require the image to be rotated.

Thus, a case where a preview of an image can be displayed properly but that image cannot be printed occurs, which causes user confusion.

### SUMMARY OF THE INVENTION

The present invention is directed to a system capable of displaying image information that has been read from a connected external storage unit cannot be output depending on print settings, on a preview screen of the image information.

According to an aspect of the present invention, an image forming apparatus includes a reading unit configured to read image information stored in an external storage unit, an analysis unit configured to analyze the read image information, a printing unit configured to execute printing based on the read image information, an identification unit configured to identify a print setting that is not to be set when the printing unit executes printing based on the image information, based on a result of an analysis by the analysis unit, a generation unit configured to generate preview image information from the image information stored in the storage unit, and a display control unit configured to display information indicating the print setting identified by the identification unit on a preview screen that displays the preview image information.

Further features of the present invention will become apparent from the following description of exemplary embodiments with reference to the attached drawings.

### BRIEF DESCRIPTION OF THE DRAWINGS

FIG. 1 is a block diagram illustrating a hardware configuration of an image forming apparatus.

FIG. 2 is a plan view illustrating an operation panel illustrated in FIG. 1.

FIGS. 3A, 3B, 3C, 3D, 3E, 3F, and 3G are diagrams each illustrating an example of an operation screen displayed on a liquid crystal display (LCD) illustrated in FIG. 2.

FIGS. 4A and 4B are diagrams each illustrating an example of an operation screen displayed on the LCD illustrated in FIG. 2.

FIGS. 5A, 5B, and 5C are diagrams each illustrating an example of an operation screen displayed on the LCD illustrated in FIG. 2.

FIG. 6 is a diagram illustrating an example of an operation screen displayed on the LCD illustrated in FIG. 2.

FIG. 7 is a flowchart illustrating a processing procedure of a method for controlling the image forming apparatus.

FIG. 8 is a flowchart illustrating a processing procedure of a method for controlling the image forming apparatus.

FIG. 9 is a flowchart illustrating a processing procedure of a method for controlling the image forming apparatus.

FIG. 10 is a flowchart illustrating a processing procedure of a method for controlling the image forming apparatus.

### DESCRIPTION OF THE EMBODIMENTS

Various exemplary embodiments, features, and aspects of the invention will be described in detail below with reference to the drawings.

<Description of System Configuration>

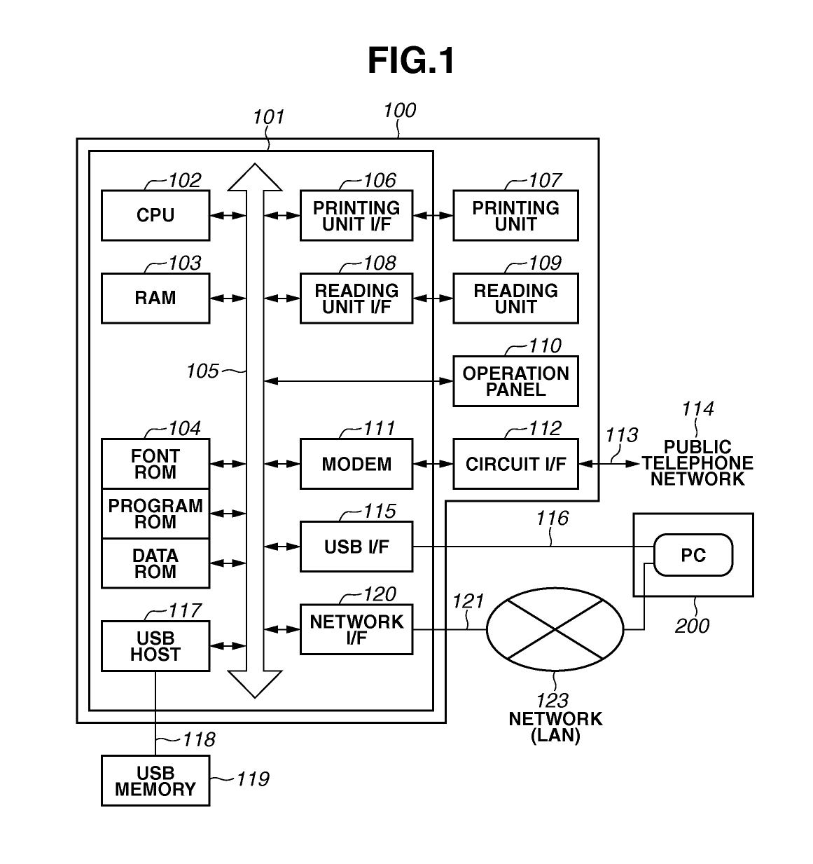

FIG. 1 is a block diagram illustrating a hardware configuration of an image forming apparatus 100 according to a first exemplary embodiment. The image forming apparatus 100 according to the first exemplary embodiment is communicably connected to an information processing apparatus through a network.

The image forming apparatus 100 includes a printing unit 107, a reading unit 109, an operation panel 110, a circuit interface (I/F) 112, and a controller unit 101 that controls the stated components. The controller unit 101 includes a central processing unit (CPU) 102, a random access memory (RAM) 103, a read only memory (ROM) 104, a printing unit I/F 106, a reading unit I/F 108, a modem 111, a Universal Serial Bus (USB) I/F 115, a USB host I/F (hereinafter, USB host) 117, and a network I/F 120. These blocks are interconnected with each other through a system bus 105.

The CPU 102 integrally controls each of the blocks in accordance with various control programs. The control programs are stored in a program area of the ROM 104, and the CPU 102 loads and executes the stored control programs. Alternatively, the CPU 102 may decompress and develop compressed data stored in the program area of the ROM 104 to the RAM 103 and execute the control programs. As another alternative, the control programs may be stored in a hard disk drive (HDD) (not illustrated) in a compressed or uncompressed state. In the first exemplary embodiment, the CPU 102 performs image processing for generating, based on received print data, print information that can be printed by the printing unit 107 by loading a control program stored in the ROM 104 or the like to the RAM 103. In addition, the CPU 102 performs processing for generating a preview image from the generated print information by loading the control program stored in the ROM 104 or the like to the RAM 103. Furthermore, the CPU 102 performs processing for analyzing image information read from a USB memory 119 by loading the control program stored in the ROM 104 or the like to the RAM 103. The CPU 102 performs processing for generating preview image information and performs control for displaying a result of the analysis on a preview screen of the generated preview image information, in accordance with the flowcharts described below.

The network I/F 120 performs communication processing to communicate with a host computer (PC) 200 through a network (LAN) 123 or the like. The network I/F 120 and the network 123 are interconnected with each other through a communication cable, such as a LAN cable 121. The modem 111 is connected with a public telephone network 114 through the circuit I/F 112 and performs communication processing to communicate with another image forming apparatus, a facsimile machine, a telephone set, or the like (not illustrated). The circuit I/F 112 and the public telephone network 114 are interconnected with each other typically through a telephone line 113 or the like.

The printing unit I/F 106 serves as an interface for outputting an image signal to the printing unit 107 (printer engine). The reading unit I/F 108 serves as an interface for accepting input of a read image signal from the reading unit 109 (scanner engine). The CPU 102 processes the read image signal input through the reading unit I/F 108 and outputs the result to the printing unit I/F 106 as the recording image signal.

The USB host 117, which is compliant with the USB standard, is connected through a USB connector 118 with the USB memory 119, which is also compliant with the USB standard, serving as an external medium. The CPU 102 reads a file in the USB memory 119 through the USB host 117. Specifically, the CPU 102 reads image information stored in a storage unit (i.e., USB memory 119) which is connected to the USB host 117.

The CPU 102 displays characters and symbols on a display area of the operation panel 110 by using font information stored in a font area of the ROM 104, and receives instruction information from the operation panel 110 that has received a user instruction.

In addition, the CPU 102 stores apparatus information of the image forming apparatus 100, telephone directory information of users, department management information, and so on in a data area of the ROM 104. The CPU 102 reads and updates each pieces of the information as necessary.

Although the reading unit 109 and the printing unit 107 are integrated in the image forming apparatus 100, one or both of the reading unit 109 and the printing unit 107 may be provided outside the image forming apparatus 100.

The PC 200 is an external apparatus, and a PC to which a scanned image is transmitted is, for example, connected to the image forming apparatus 100.

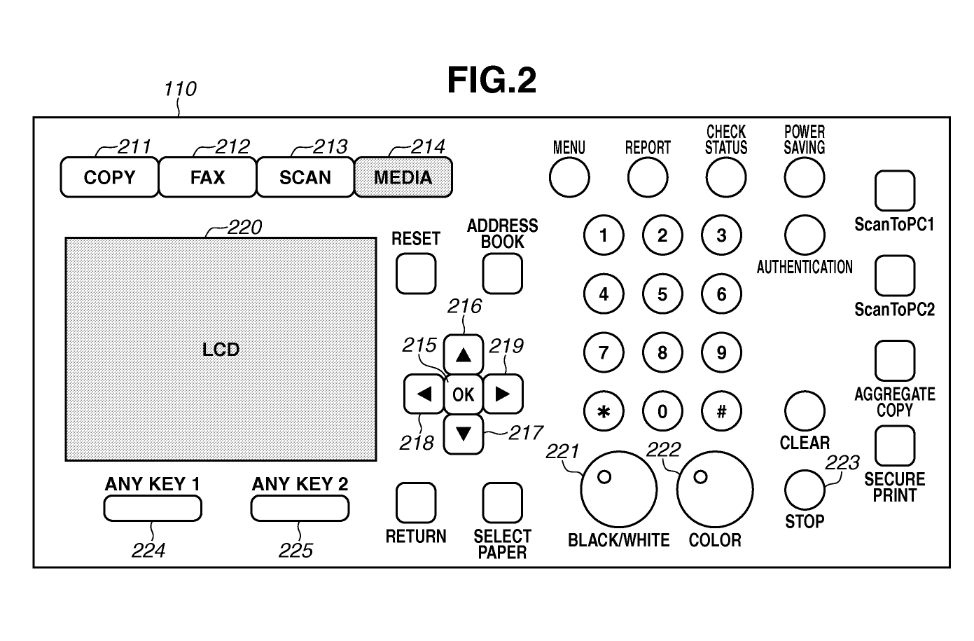

FIG. 2 is a plan view illustrating the operation panel 110 illustrated in FIG. 1.

The operation panel 110 includes a function key 211 for a “copy” function, a function key 212 for a “fax” function, a function key 213 for a “scan” function, and a function key 214 for a “media direct print” function. Pressing any one of these function keys 211 to 214 shifts the display to a basic screen for each of the selected job. A function key corresponding to the selected function is lit.

The “media direct print” function has been selected in FIG. 2. An OK key 215 is used to confirm a selected item. Up, down, right, and left arrow keys 216 to 219 are used to select items. An LCD 220 displays an operation screen.

A start key 221 for black and white printing is lit when the start key 221 can be pressed. In a similar manner, a start key 222 for color printing is lit when the start key 222 can be pressed. Pressing the start key 221 for black and white printing or the start key 222 for color printing causes a media direct print job of the first exemplary embodiment to be executed. A stop key 223 is used to stop job processing.

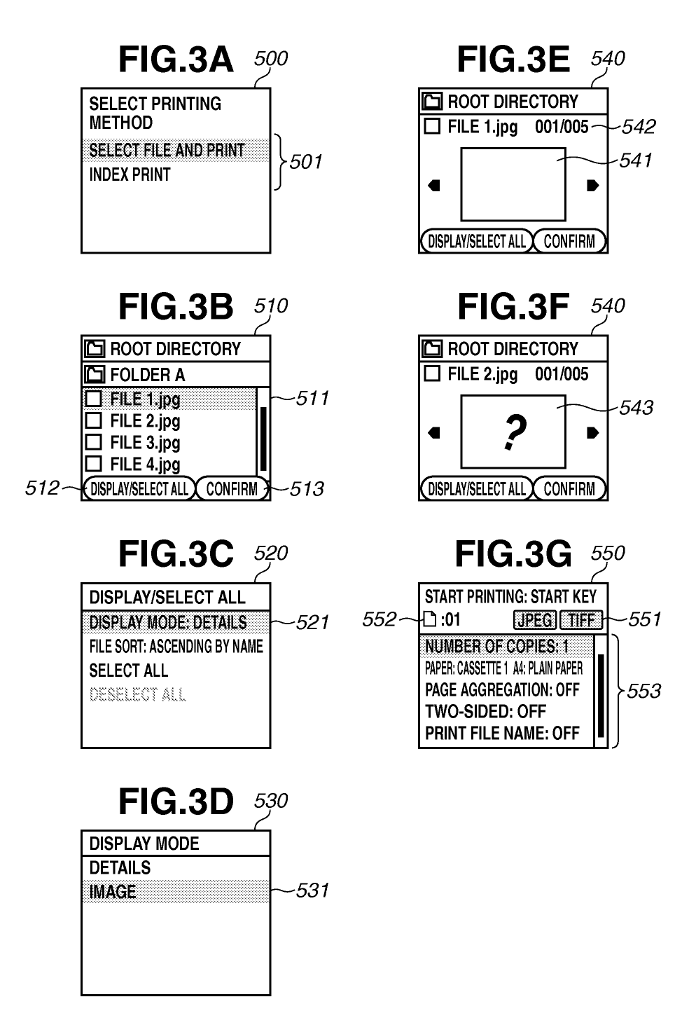

FIGS. 3A, 3B, 3C, 3D, 3E, 3F, and 3G are diagrams each illustrating an example of an operation screen displayed on the LCD 220 illustrated in FIG. 2. Each example illustrates transitions of a screen for selecting a file to be printed when information registered in a medium connected to the image forming apparatus 100 is printed.

FIG. 3A corresponds to a screen example for the media direct print function selected through the operation panel 110. Upon pressing the function key 214 for the media direct print job, a basic screen 500 illustrated in FIG. 3A is displayed on the LCD 220. The basic screen 500 for media direct printing includes seven lines. A message for selecting a printing method is displayed on the first and second lines. Print units 501 are displayed in the third and fourth lines, and pressing the OK key 215 on the operation panel 110 shifts the display to a file browsing screen.

FIG. 3B illustrates a file browsing screen 510 displayed when the user has selected either one of the print units 501 displayed on the third and fourth lines of the basic screen 500 illustrated in FIG. 3A.

In the file browsing screen 510 illustrated FIG. 3B, a list of folders and files in a root directory is displayed, and file names are displayed in ascending order by name in the initial state. When the list of the files does not fit within the screen, a scroll bar 511 is displayed on the right side. A display/select all button 512 and a confirm button 513 are displayed on the seventh line, and the user can select the display/select all button 512 and the confirm button 513 by pressing panel keys 224 and 225, respectively.

The user can select a file to be printed by pressing the OK key 215 on the operation panel 110. If the user selects a folder, the display is shifted to a selected folder level, and the display shifts to a browsing screen displaying a list of files in the selected folder. In the first exemplary embodiment, the user can select multiple files for printing, and pressing the OK key 215 again while files are selected causes the files to become deselected. When all of the files in the root directory are to be selected or when all of the selected files in the root directory are to be deselected, the user may press the panel key 224 on the operation screen 110 to select the display/select all button 512, and the operation screen then displays a display/select all screen 520 illustrated in FIG. 3C. The user can switch the display to a preview display in a similar manner. When at least one file is selected on the file browsing screen 510, the user can select the confirm button 513 on the seventh line, and pressing the panel key 225 on the operation panel 110 shifts the display to a print setting screen 550 illustrated in FIG. 3G.

FIG. 3C is a diagram illustrating the display/select all screen 520, through which the user can change a file display mode, sort files, and select or deselect all files. Upon pressing the OK key 215 while a cursor 521 is placed on the display mode on the second line, the display is shifted to a display mode change screen 530 illustrated in FIG. 3D.

FIG. 3D is a diagram illustrating the display mode change screen 530, through which the user can switch between list (detail) display and image (preview) display. Upon the user pressing the OK key 215 while a cursor 531 is placed on “image,” a preview screen 540 illustrated in FIG. 3E is displayed.

In the preview screen 540 illustrated in FIG. 3E, the first line indicates the current folder level, the second line indicates a file name and a current location 542 with respect to the entire files in the directory. The third to sixth lines display a reduced image (preview image) 541 of the file indicated on the second line.

The user can select a currently displayed file by pressing the OK key 215 on the operation panel 110. Pressing the OK key 215 again while a file is selected causes the selected file to become deselected. In addition, the user can switch the reduced image to be displayed with the left arrow key 218 and the right arrow key 219 on the operation panel 110, and pressing the OK key 215 allows multiple files to be selected. As in the file browsing screen 510 illustrated in FIG. 3B, when at least one file is selected on the preview screen 540, the user can select the confirm button 513 on the seventh line, and pressing the panel key 225 on the operation panel 110 shifts the display to the print setting screen 550 illustrated in FIG. 3G to be displayed.

FIG. 3F is a diagram illustrating a screen example displaying a preview error, and an error icon 543 is displayed when a reduced image (preview image) cannot be generated due to a case where, for example, a file is damaged or an image decoding error has occurred.

FIG. 3G is a diagram illustrating the print setting screen 550 for the media direct printing, and the print setting screen 550 corresponds to a reception screen that receives print settings. The first line displays an item for a print start instruction. Displayed on the second line are an icon 551 indicating a file format of a selected file and the number 552 of the selected files. The print setting screen 550 illustrated in FIG. 3G indicates an example in which a single file has been selected through the screen illustrated in FIG. 3B or 3E. The third line indicates the number of copies. The fourth line indicates the print paper size, the paper type, and the tray level. The fifth line indicates a page aggregation option, and 1-up, 2-up, or 4-up printing, for example, can be selected.

When a list of the print setting items does not fit within a space on and below the third line, a scroll bar 553 is displayed on the right side. The user can change the menu item settings by pressing the OK key 215 to select a given item.

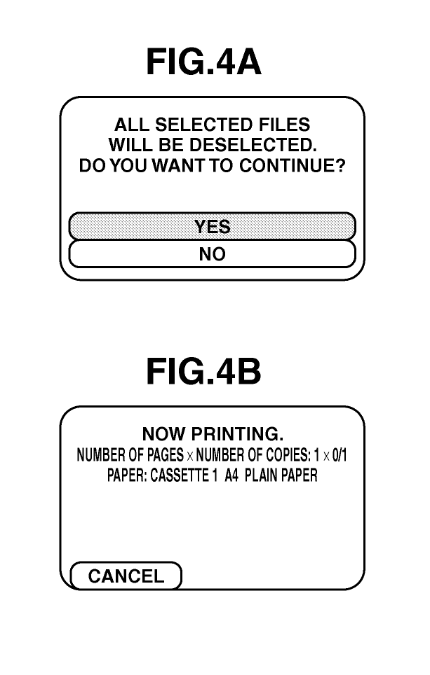

FIGS. 4A and 4B are diagrams each illustrating an example of an operation screen displayed on the LCD 220 illustrated in FIG. 2. These examples illustrate pop-up screens related to the media direct printing.

The operation screen illustrated in FIG. 4A is displayed when the user instructs all of the selected files to be deselected through the display/select all screen 520 illustrated in FIG. 3C or when a folder on another level is displayed. In the first exemplary embodiment, the user cannot simultaneously select files located on different levels in the directory hierarchy but can select multiple files on the same level, and thus changing a folder to browse through causes selected files to become deselected.

FIG. 4B illustrates the pop-up screen displayed while the media direct printing is in progress. The number of printed pages is counted in accordance with the printing state.

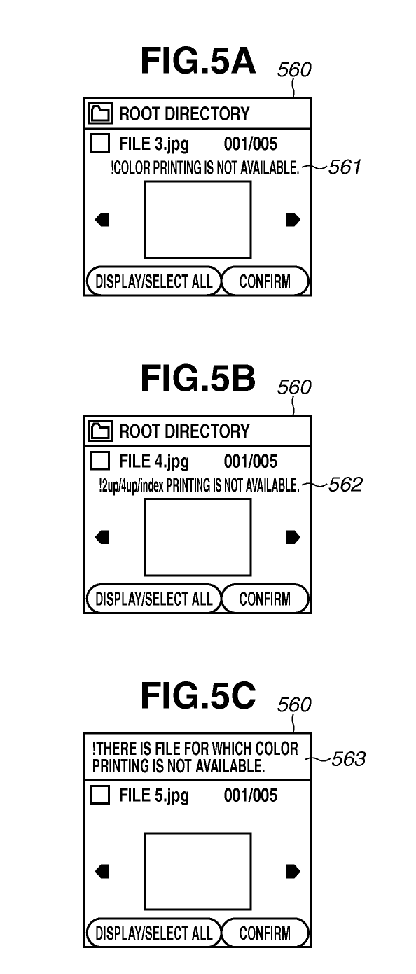

FIGS. 5A, 5B, and 5C are diagrams each illustrating an example of an operation screen displayed on the LCD 220 illustrated in FIG. 2. Herein below, an example of media direct print control of the first exemplary embodiment will be described with reference to the operation screens illustrated in FIGS. 5A, 5B, and 5C.

On the operation screen illustrated in FIG. 5A, a condition on which the displayed image cannot be printed is displayed on the third line of the preview screen. The operation screen illustrated in FIG. 5A illustrates a preview screen example to be displayed in a case where file3.jpg is an image that cannot be printed in color. In such a case, the preview image is displayed in monochrome.

The operation screen illustrated in FIG. 5B is an example indicating a condition on which file4.jpg becomes unable to be printed depending on a layout setting. The operation screen illustrated in FIG. 5C is an example in which a toggle is displayed on the first line, in a case where multiple files have been selected, and there is at least one image that cannot be printed among the selected files due to the print settings.

In any of the above-described cases, the location where a printing unavailable condition is displayed or the content thereof is not limited to the configuration described above, and modifications may be made in accordance with the screen size or the user interface (UI) design.

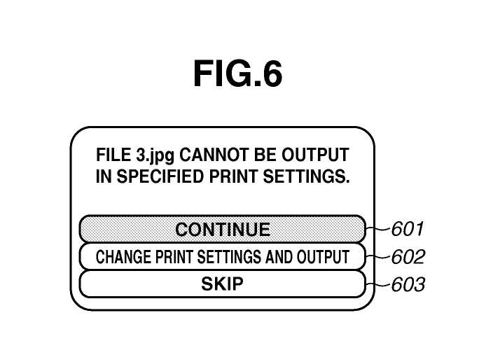

FIG. 6 is a diagram illustrating an example of an operation screen displayed on the LCD 220 illustrated in FIG. 2. This example illustrates a pop-up screen to be displayed immediately after the media direct printing has been started.

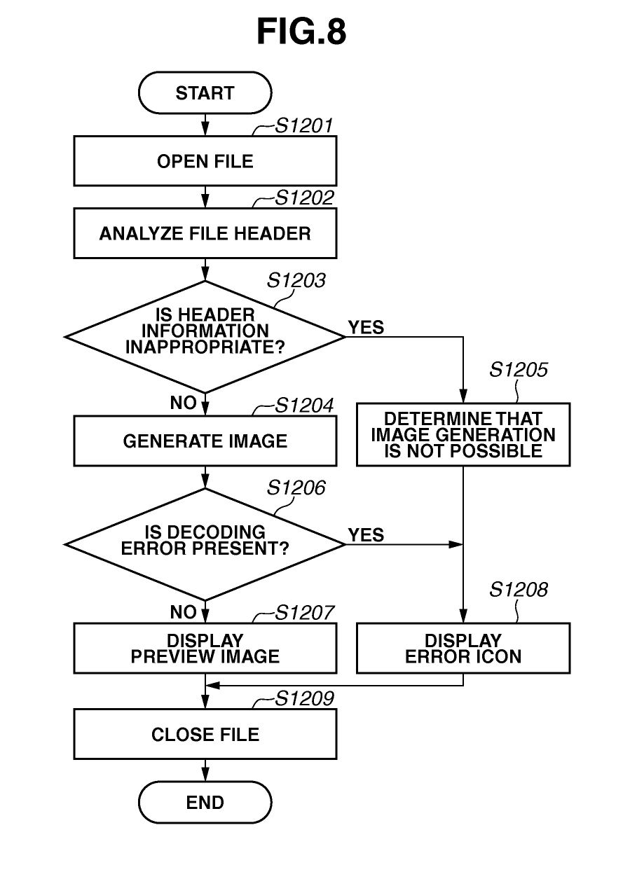

In a case where the user has selected a file without checking the image through the preview display, for example, in a case where the user has selected a file through the detail (list) display or in a case where the user has selected multiple files at once, the pop-up screen illustrated in FIG. 6 is displayed upon the user pressing the start key 221 or 222 on the operation panel 110 to instruct the media direct printing to be started. The example illustrated in FIG. 6 corresponds to a pop-up screen that is displayed by the CPU 102, for example, when the CPU 102 determines, in step S1203 of FIG. 8, that the header information of a given file is inappropriate and the file thus cannot be printed through given print settings.

In the operation screen illustrated in FIG. 6, a selection button 601 for continuing printing even if the file contains an image that causes a printing error, and a selection button 603 for printing the file with an image causing a printing error being skipped. A selection button 602 is displayed if the file contains an image that can be printed without an error through different print settings, and allows the print settings for only a relevant image to be changed.

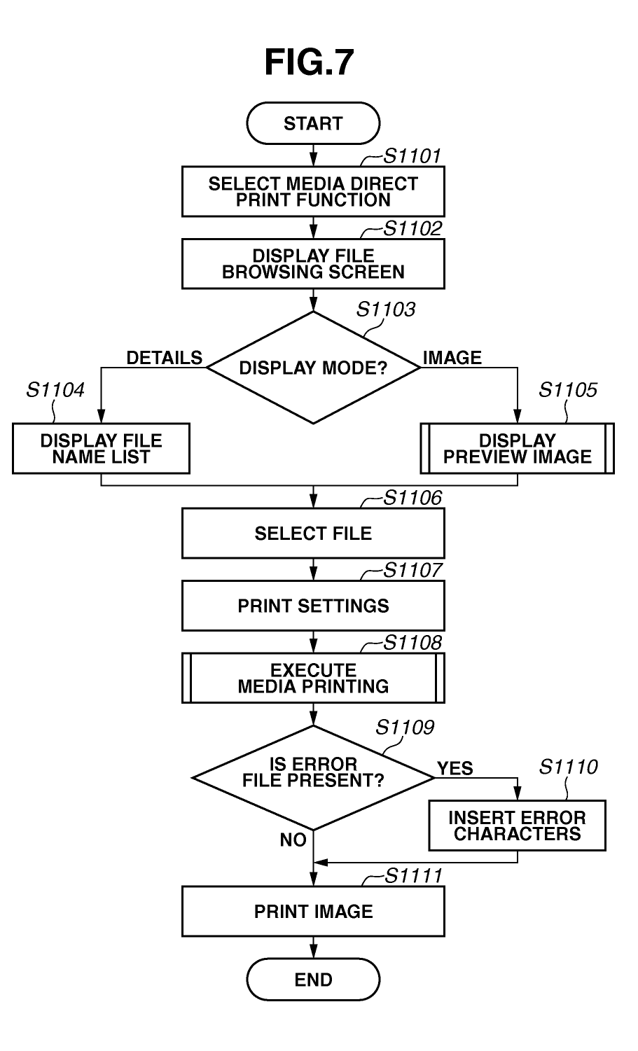

FIG. 7 is a flowchart illustrating a processing procedure of a method for controlling the image forming apparatus of the first exemplary embodiment. This example corresponds to a processing example covering from input of the media direct print job to the end of the job processing. Each of the steps is realized by the CPU 102 executing the stored control program.

Upon turning on the power supply of the image forming apparatus 100, the user presses the function key 214 for the media direct printing through the operation panel 110. In step S1101, the CPU 102 shifts the display to a media direct print function top screen (basic screen 500 illustrated in FIG. 3A) on the operation panel 110.

The user then selects a file to be printed from among the menu items on the media direct print function top screen (basic screen 500 illustrated in FIG. 3A). Upon the user selecting “print” or “index print” by pressing the OK key 215, in step S1102, the CPU 102 shifts the display from the basic screen 500 illustrated in FIG. 3A to the display mode change screen 530 illustrated in FIG. 3D.

In step S1103, the CPU 102 determines whether the user has selected “detail” or the user has selected “image” as the settings for the display mode through the display mode change screen 530 illustrated in FIG. 3D. If the CPU 102 determines that the user has selected “detail (list)” of file names as the display mode, in step S1104, the CPU 102 displays a list of file names in the folder (information list) and the processing proceeds to step S1106.

Meanwhile, if, in step S1103, the CPU 102 determines that the user has selected “image,” or preview image display in this case, as the display mode, in step S1105, the CPU 102 displays a preview of a file on the top in the directory.

In step S1106, the CPU 102 detects that the user has selected a file to be printed through the file browsing screen 510 illustrated in FIG. 3B or the preview screen 540 illustrated in FIG. 3E. At this point, the user selects a file to be printed and confirms the selection by operating the confirm button 513. Upon the CPU 102 detecting the confirm button 513 having been pressed, the CPU 102 shifts the display to the media direct printing print setting screen 550 illustrated in FIG. 3G. In step S1107, the CPU 102 then detects that the user has set the print settings through the media direct printing print setting screen 550 illustrated in FIG. 3G. In step S1108, when the CPU 102 confirms that either of the start key 221 for black and white printing and the start key 222 for color printing has been pressed, the CPU 102 starts print processing (media direct print processing).

In step S1109, the CPU 102 determines whether there is a file on which an error has occurred during the header analysis or the image processing. If the CPU 102 determines that an error has occurred (YES in step S1109), in step S1110, the CPU 102 performs processing for inserting error characters or the like. Thereafter, in step S1111, the CPU 102 performs the print processing and then ends the processing.

Although, in a case where an error image exists, a sheet on which the character string “ERROR” has been printed is output instead of outputting the image in the present exemplary embodiment, different data processing registered in advance may be performed. For example, in addition to the character string “ERROR,” an error file name, a file attribute, a file date, and so on may be printed.

If the CPU 102 determines, in step S1109, that there is no file on which an error has occurred (NO in step S1109), in step S1111, the CPU 102 prints the selected images in accordance with the print settings set in step S1107 and then ends the processing.

FIG. 8 is a flowchart illustrating a processing procedure of a method for controlling the image forming apparatus of the present exemplary embodiment. This example details the preview display processing (step S1105) in the media direct printing by the image forming apparatus 100. This processing flow is applied in a case where the display setting during file browsing is image display. Each of the steps is realized by the CPU 102 executing the stored control program.

In step S1201, the CPU 102 opens a file to be previewed read from the USB memory 119. In step S1202, the CPU 102 analyzes the header information of the file. In step S1203, the CPU 102 determines whether the header information is inappropriate. If the CPU 102 determines that the header information is inappropriate, as in a case where, for example, the image is damaged (YES in step S1203), in step S1205, the CPU 102 determines that the image forming apparatus 100 cannot generate an reduced image. When the CPU 102 determines that the reduced image cannot be generated, in step S1208, the CPU 102 displays an error icon on the operation panel 110 without carrying out image processing and the processing proceeds to step S1209.

If, in step S1203, the CPU 102 determines that the header information of the file is appropriate (NO in step S1203), in step S1204, the CPU 102 starts predetermined image processing to start generating the reduced image for the preview.

In step S1206, the CPU 102 determines whether an image decoding error or the like has occurred while generating the reduced image. If the CPU 102 determines that the decoding error has occurred (YES in step S1206), the CPU 102 interrupts the predetermined image processing and the processing proceeds to step S1208 to display an error icon, as in the case of the header analysis error.

If, in step S1206, the CPU 102 determines that the image processing has been properly completed (NO in step S1206), in step S1207, the CPU 102 displays the generated reduced image on the operation panel 110. The CPU 102 then determines that the predetermined image processing has been completed, and in step S1209, the CPU 102 closes the file opened in step S1201 and ends the processing.

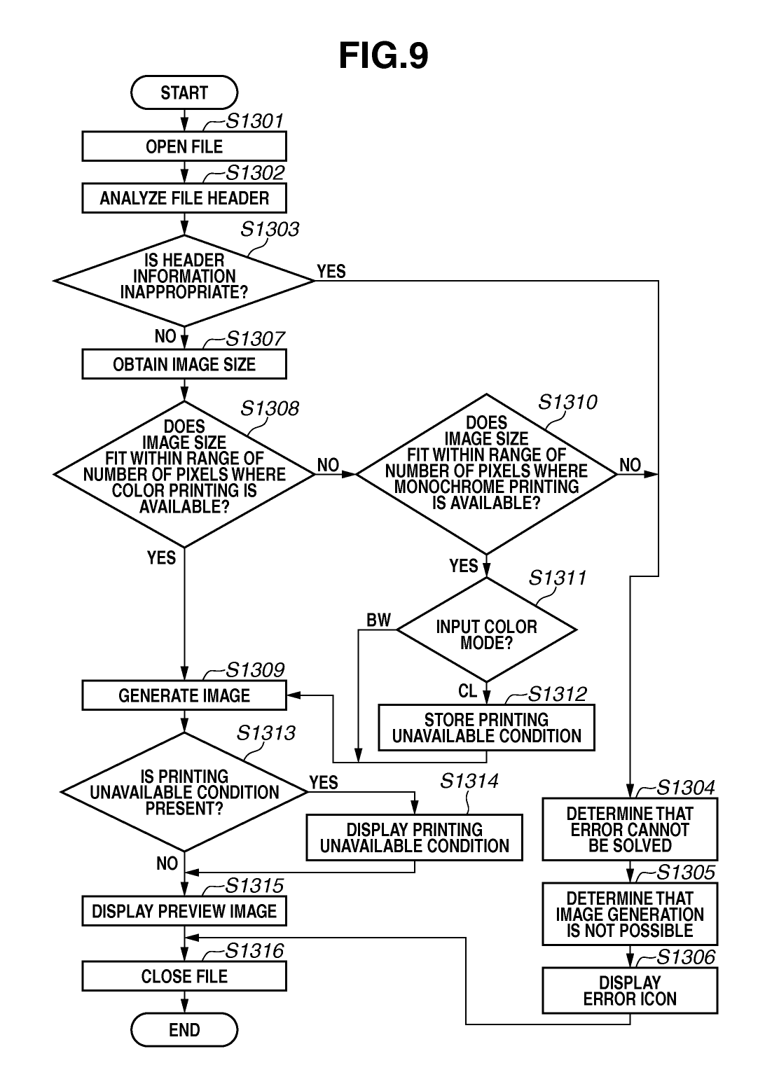

FIG. 9 is a flowchart illustrating a processing procedure of a method for controlling the image forming apparatus of the present exemplary embodiment. This example corresponds to a processing example for displaying a printing unavailable condition along with a preview image. Each of the steps is realized by the CPU 102 executing the stored control program. Herein below, the preview display processing (step S1105), in a case where the display setting during file browsing is the image display, will be described.

The present exemplary embodiment provides a solution that can be employed in an image forming apparatus provided with an image processing chip having a limitation in that the range of the number of pixels that can be subjected to image processing differs between color printing and monochrome printing and the permissible range is smaller for color printing than for monochrome printing. File formats supported in the media direct print function of the first exemplary embodiment are the joint photographic expert group (JPEG) and the tagged image file format (TIFF). The solution can also be applied to an image forming apparatus supporting PDF direct printing, and the file formats are thus not limited to JPEG and TIFF.

When displaying a preview image or printing an image, image processing is performed with the use of image processing hardware provided in an image forming apparatus controller. The image processing here may include JPEG decoding processing, decoding processing in accordance with compression formats, such as Modified Huffman (MH) and Modified Modified READ (MMR) in the case of a TIFF file, zooming processing (enlargement/reduction), trimming processing (cut), brightness adjustment, and character/photograph priority adjustment. Such image processing operations are performed with different image processing chips, and the specifications are determined in accordance with the performance of the image processing chips.

Thus, with low-priced image forming apparatuses facing increased cost competitions, it is not possible to avoid a limitation on the size (the number of pixels) of an image that can be processed or on an image processing function, if high performance image processing chips cannot be mounted.

In the present exemplary embodiment, a method for overcoming a limitation on the image size of an image processing chip that performs the zooming processing (enlargement/reduction) will be described as an example. The stated limitation on the image size refers to a limitation on the size (the number of pixels in a main scanning direction) of an image that can be output after color data zooming processing, and the size of an image that can be output reliably is a size corresponding to an A4 size at a maximum in the case of color data and a size corresponding to a legal (LGL) size at a maximum in the case of monochrome data.

For example, an image file of an oblong image is to be printed on an A4 size sheet by the media direct printing, the magnification ratio for enlargement is typically calculated based on the number of pixels in a sub-scanning direction along a shorter side according to the FitToPage specification. The stated limitation, however, causes the number of pixels of an image enlarged at a specified magnification ratio to exceed the upper limit of the number of pixels in the main scanning direction that can be output, only in a case where the image is a color image. Thus, the enlarged image cannot be output properly, and part of the image (right end portion) becomes corrupted.

In this manner, the stated limitation on the size (the number of pixels) of an image that can be output after image zooming leads to a variation in the result in that some processed images cannot be output depending on their image sizes. In addressing such an issue, herein below, a method for checking an input image size in advance will be described. The vertical and horizontal size (the number of pixels) of an image that has not been subjected to image processing is determined in advance, and it is determined in advance whether the image can be subjected to the color image processing, only to the monochrome image processing, or to neither the color image processing nor the monochrome image processing.

In the present exemplary embodiment, the preview display processing (step S1105) is employed in a case where the display setting during file browsing is the image display.

Flow from opening a file to displaying an error icon when an error occurs in the header analysis (steps S1301 to S1306) are the same as that in the preview display processing (steps S1201 to S1203, S1205, and S1208 of FIG. 8) described above.

If, in step S1303, the CPU 102 determines that the header information is appropriate (NO in step S1303), in step S1307, the CPU 102 obtains the image size (the number of pixels along the vertical and horizontal directions), and, in step S1308, the CPU 102 determines whether the obtained image size falls within the range of the number of pixels where color printing is available. If the CPU 102 determines that the image size falls within the range (YES in step S1308), in step S1309, the CPU 102 properly generates a reduced image.

If the CPU 102 determines that the image size falls outside the range (NO in step S1308), in step S1310, the CPU 102 determines whether the image size falls within the range of the number of pixels where monochrome printing is available. If the CPU 102 determines that the image size falls outside the range (NO in step S1310), in step S1304, the CPU 102 determines that the image forming apparatus 100 cannot solve the error. In step S1305, the CPU 102 does not carry out image processing. In step S1306, the CPU 102 then displays an error icon and proceeds to step S1316.

In step S1311, the CPU 102 determines an input color mode, and if the CPU 102 determines that color printing is not available but monochrome printing is available, in step S1312, the CPU 102 stores a printing unavailable condition in the RAM 103 and the processing proceeds to step S1309. In step S1309, the CPU 102 generates a reduced image. The printing unavailable condition indicates that color printing is not available. After generating the reduced image and prior to displaying the generated reduced image on the LCD 220, in step S1313, the CPU 102 determines whether the printing unavailable condition is already stored in the RAM 103. If the CPU 102 determines that the printing unavailable condition is already stored in the RAM 103 (YES in step S1313), in step S1314, the CPU 102 displays the printing unavailable condition on the LCD 220 and then, in step S1315, the CPU 102 displays the generated reduced image as well. In step S1316, as post processing, the CPU 102 closes the opened file and ends the processing.

As described above, according to the present exemplary embodiment, when a preview of a selected file is displayed, print settings that do not allow the selected file to be printed can be identified, and the user can check the stated print settings. In addition, since such print settings that cause a printing error are prevented from being selected, an output result which the user does not intend can be prevented in advance. Furthermore, since a discrepancy between an image checked through a preview and an output result can be suppressed, confusion of a user can be reduced.

In the first exemplary embodiment described above, an example in which both a preview image and a printing unavailable condition are displayed, in a case of where the preview display setting is set, has been illustrated. However, there may be a case where, as another file selection flow, the user selects an image to be printed without checking the preview image, as in a case where, for example, the user selects a file through the detail (list) display of files or in a case where the user selects multiple files at once.

In a second exemplary embodiment, a method for avoiding “an image that cannot be printed depending on the print settings” even in a case where the user selects a file without checking the preview image will be described.

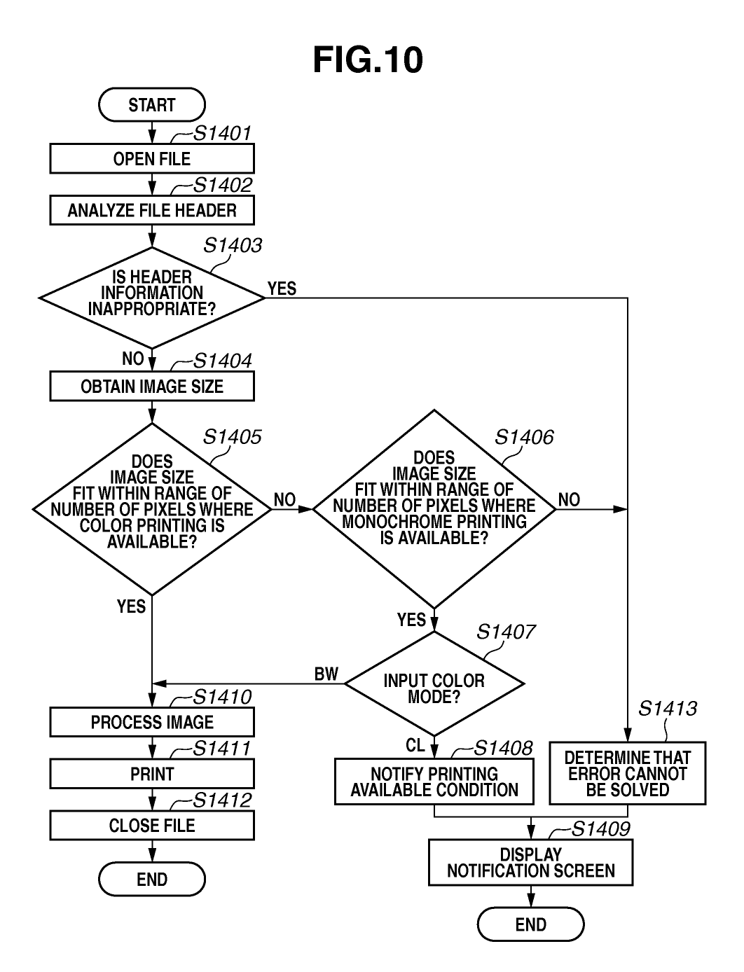

FIG. 10 is a flowchart illustrating a processing procedure of a method for controlling the image forming apparatus of the second exemplary embodiment. This example corresponds to a processing example when the media direct printing is executed, unlike the case illustrated in FIG. 9. Each of the steps is realized by the CPU 102 executing the stored control program.

Preview image generation processing flow and print processing flow are basically the same as those described in the first exemplary embodiment, and since processes in steps S1401 to S1403 are the same as those in steps S1301 to S1303 in the first exemplary embodiment, descriptions thereof will be omitted.

If, in step S1403, the CPU 102 determines that an error has occurred in the file header analysis (YES in step S1403), in step S1413, the CPU 102 determines that the error cannot be solved and stops the print processing. In step S1409, the CPU 102 then displays the pop-up screen illustrated in FIG. 6 and ends the processing.

If, in step S1403, the CPU 102 determines that the header information is appropriate (NO in step S1403), in step S1404, the CPU 102 obtains the input image size. In step S1405, the CPU 102 determines whether the obtained input image size falls within the range of the number of pixels where color printing is available. If the CPU 102 determines that the input image size falls outside the range of the number of pixels where color printing is available (NO in step S1405), the processing proceeds to step S1406. In step S1406, the CPU 102 then determines whether the input image size falls within the range of the number of pixels where monochrome printing is available. If the CPU 102 determines that monochrome printing is available (YES in step S1406), in step S1407, the CPU 102 determines whether the input color mode is a color mode or a monochrome mode.

If the CPU 102 determines that the input color mode is the color mode, this corresponds to a case where the CPU 102 has determined that the image can be printed not through color printing but through monochrome printing, and thus in step S1408, the CPU 102 generates a message notifying that the image can be printed through monochrome printing instead of color printing. In step S1409, the CPU 102 then displays the pop-up screen illustrated in FIG. 6 and ends the processing.

If, in step S1407, the CPU 102 determines that the color mode is monochrome, or in other words, if the CPU 102 determines that an error has not occurred in the file header analysis or in the image processing, the processing proceeds to step S1410. In step S1411, the CPU 102 then properly prints the image.

In the second exemplary embodiment, the user can select an output mode of an image causing a printing error through the pop-up screen illustrated in FIG. 6. The pop-up screen includes three selectable items, namely continuing with printing, printing with an image causing a printing error being skipped, and avoiding an error through different print settings, and the print processing resumes in accordance with a selected item.

A timing at which the notification screen is displayed may fall during printing or after printing is completed, instead of immediately after printing starts. In addition, the number of the selectable items does not need to be three, and the number of the items may be changed in accordance with an error condition of an image. Furthermore, when the print settings have been changed, printing of each of a job before and after the change can be executed as a single job or may be executed as separate jobs.

As described above, according to the present exemplary embodiment, even in a case where the user has selected a file without checking an image through the preview display, the user can recognize “an image that cannot be printed depending on the print settings” immediately after the printing starts. In addition, the second exemplary embodiment not only prevents an output result that is not intended by the user but also allows the user to realize that an error can be avoided through different print settings, and thus the user can retry to print the image as necessary.

Each of the steps in the exemplary embodiments of the present invention can also be realized by a processing device (CPU, processor) of a PC (computer) executing software (program) obtained through a network or in the form of various storage media.

The present invention is not limited to the exemplary embodiments described above. Various modifications (including an organic combination of the exemplary embodiments) can be made based on the spirit of the present invention, and such modifications are encompassed within the scope of the present invention.

As described above, according to the exemplary embodiments, an indication that image information that has been read from an external storage unit cannot be output through the print settings can be displayed on a preview screen for the image information.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-115487 filed May 31, 2013, which is hereby incorporated by reference herein in its entirety.

What is claimed is:

1. An image forming apparatus, comprising:
a reading unit configured to read image information stored in an external storage unit;
an analysis unit configured to analyze the read image information;
a printing unit configured to execute printing based on the read image information;
an identification unit configured to identify a print setting that is not to be set when the printing unit executes printing based on the image information, based on a result of an analysis by the analysis unit;
a generation unit configured to generate preview image information from the image information stored in the storage unit; and
a display control unit configured to display information indicating the print setting identified by the identification unit on a preview screen that displays the preview image information.

2. The image forming apparatus according to claim 1, wherein the display control unit controls a screen for receiving the print setting identified by the identification unit not to be displayed for the image information read by the reading unit.

3. The image forming apparatus according to claim 1, further comprising:
a first selection unit configured to select one of a first display mode and a second display mode for displaying the read image information,
wherein the display control unit displays list information of the read image information when the first display mode is selected, and displays a preview of the read image information when the second display mode is selected.

4. The image forming apparatus according to claim 3, further comprising:
a second selection unit configured to select a piece of image information to be printed from the list information of the image information which is read by selecting the first display mode;
a determination unit configured to determine whether the selected piece of image information includes image information that is not to be printed through a set printing setting;
a screen display unit configured to display a screen for receiving an instruction for executing printing by changing the set print setting, in a case where the image information that is not to be printed is included; and
an image processing unit configured to perform image processing on the selected piece of image information with the set print settings having been changed.

5. A method for controlling an image forming apparatus, comprising:
reading image information stored in an external storage unit;
analyzing the read image information;
executing printing based on the read image information;
identifying a print setting that is not to be set when executing printing based on the image information, based on the analyzed image information;
generating preview image information from the image information stored in the storage unit; and
displaying information indicating the identified print setting on a preview screen that displays the generated preview image information.

6. A non-transitory storage medium storing a program for implementing a method for controlling an image forming apparatus, the method comprising:
reading image information stored in an external storage unit;
analyzing the read image information;
executing printing based on the read image information;
identifying a print setting that is not to be set when executing printing based on the image information, based on the analyzed image information;
generating preview image information from the image information stored in the storage unit; and
displaying information indicating the identified print setting on a preview screen that displays the generated preview image information.
